(19) United States
(12) Patent Application Publication
(10) Pub. No.: US 2007/0190995 A1
(43) Pub. Date: Aug. 16, 2007

(54) Remote control of a mobile device

(75) Inventors: Feiyun Wang, Beijing (CN); Bing Dai, Beijing (CN); Bing Zhang, Beijing (CN); Zhongxiong Jiang, Beijing (CN); Jiang-Lilian Li, Beijing (CN); Huan Zhu, Beijing (CN); Walter Wong, Beijing (CN); Zengxin Yu, Beijing (CN); Peng Lan, Beijing (CN); Lei Yang, Beijing (CN)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/354,271

(22) Filed: Feb. 13, 2006

(51) Int. Cl. H04M 3/00

(52) U.S. Cl. 455/419

(57) ABSTRACT

A method for remotely controlling a mobile device, comprising the steps of parsing a message delivered to a wireless device, obtaining a command included in the message, such command indicating a function of the wireless device, and performing the function indicated by the command. The command may cause the wireless device to modify information stored in the device, to change one or more configuration parameters of the device, or to forward information stored in the device to an address. A wireless device and a computer program product for performing the method are also provided. The computer program product may be an application incorporated into NOKIA® PC Suite for mobile devices.

### TECHNICAL FIELD

The present invention pertains to telecommunications, and more particularly to remote controlling of a mobile electronic device such as a mobile phone.

### BACKGROUND ART

Almost all mobile phones are capable of sending and receiving text messages. More advanced mobile phones are equipped with an email client as a standard application, so that the mobile phones can, in addition to sending text messages, send and receive email messages to and from any email address.

There are different ways for a mobile device to access emails. One method is called Push-and-Pull Email. With this method, a message arrives at a network server and the server stores the message. A header of the message is sent to the mobile device as a notification (push). The user connects the server from the mobile device to retrieve the message (pull). Airtime is normally charged for downloading the message.

Another method is called Push Email. A message including the entire content is delivered, i.e. “pushed,” by a network server to the targeted mobile device and the message is stored in the mobile device. The network server normally does not store the message. A user can open the email without having to connect to the server.

Nowadays most wireless telephony providers can push an email message directly to a mobile device if the message is sent to a particular email address that is associated with the device. More and more mobile phones are designed to incorporate the Push Email feature.

Since mobile devices have become an important part of daily life, oftentimes it is very inconvenient if a user inadvertently loses direct access to a mobile device. Sometimes the device is left temporarily at a location out of a user's reach. Sometimes the device is lost or stolen. If a user temporarily loses access to a mobile device, the user at the time cannot access phone calls, text messages, email messages and contact information, etc. that are normally accessible only through the mobile device. If a device is lost or stolen, the user may wish to delete sensitive information from the device or transport the sensitive information from the lost or stolen device to another device, or disable the device to prevent misuse.

In such situations, it would be desirable if a mobile device can be remotely controlled to perform some functions that are normally executed by a direct access. For example, the mobile device is advantageously configured through another device or a server, so that the device will forward missed phone calls, text messages, emails, and the like, to another device or an email address that the user can access.

Therefore, what is needed is a method to remotely control a mobile device.

### SUMMARY OF THE INVENTION

In a first aspect of the invention, a method for remotely controlling a mobile device is provided. The method comprises the steps of parsing a message delivered to a wireless device, obtaining a command included in the message, such command indicating a function of the wireless device, and performing the function indicated by the command.

The message may comprise a password and the function indicated by the command may be performed only if the password matches a record in the wireless device.

The message may comprise a phone number, and the command causes the wireless device to forward a communication directed to the wireless device to a device associated with the phone number. Such a communication may be a voice call or a text message.

The message may comprise an address, and the command causes the wireless device to forward a communication to the address. Such an address may be an email address. Such a communication may be an email message or a text message directed to the wireless device, or a status message generated by the step of performing the function indicated by the command.

The command may cause the wireless device to modify information stored in the device, to change one or more configuration parameters of the device, or to forward information stored in the device to the address.

The message may be at least partially encrypted according to an algorithm and the method may further comprise a step of decrypting the message according to the algorithm.

The message may contain an indication that the message includes the command, and the method may further comprise a step of determining whether or not to parse the message according to the indication.

The message may be an email message deliverable by a Push Email service of a wireless communication network, or a text message deliverable by a text messaging service of a wireless communication network.

In a second aspect of the invention, a wireless device is provided. The wireless device comprises means for parsing a message delivered to the device, means for obtaining a command included in the message, such command indicating a function of the device, and means for performing the function indicated by the command.

In a third aspect of the invention, a computer program product is provided. The computer program product comprises instructions for parsing a message delivered to the device, instructions for obtaining a command included in the message, such command indicating a function of the device, and instructions for performing the function indicated by the command.

The message may further comprise a password and the program product may further comprise instructions for comparing the password with a record stored in the device, and instructions for performing the function indicated by the command only if the password matches the record.

The message may further comprise a phone number and the program product may further comprise instructions for forwarding a communication directed to the device to another device associated with the phone number.

The message may further comprise an address and the program product may further comprise instructions for forwarding a communication directed to the device to the address.

The message may further comprise an address and the program product may further comprise instructions for composing a status message containing information generated by performing the function indicated by the command, and instructions for transmitting the status message to the address.

The message may contain an indication that the message includes the command, and the program product may further comprise instructions for determining whether or not to parse the message according to the indication.

The computer program product of the invention may by an application incorporated into NOKIA® PC Suite for mobile devices.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a flow diagram according to the first embodiment of the invention; and

FIG. 2 is a flow diagram according to the second embodiment of the invention.

### DETAILED DESCRIPTION OF THE INVENTION

The invention provides a method for remotely controlling a mobile device. The mobile device is controlled by a message sent from another device. The message contains a control command for the mobile device to perform a function indicated by the command. The message of the invention is not limited to a particular type. In one example, a message can be a text message delivered to the mobile device by a so-called short message service (SMS). In another example, since email client is a standard application for advanced mobile phones and the Push Email feature is enabled by most wireless telephony provider, the message can be an email message. An email message for remote control can be sent to the mobile device via Internet from any email address.

Upon receiving the message, the mobile device activates an application that parses the message to obtain the control command. According to the command, the mobile device performs one or more functions. These functions are normally performed in response to a user keying in the commands directly on the mobile device.

For security reasons, the message also contains a password, and the mobile device receiving the message should at least authenticate the message according to the password. Preferably, the message is encrypted at the sending device and decrypted at the targeting mobile device. The message may further contain an email address, a phone number of a second device, or the like, so that the mobile device can forward status information to the email address or forward incoming calls to the second device accordingly.

Almost all menu items of a mobile device can be executed by a remote command. Examples of remote control commands include:
commands for the mobile device to start forwarding any missed phone call numbers, text messages and emails, etc. to an email address.
commands for the mobile device to divert incoming phone calls, text messages and voice mails, etc. to another phone number.
commands for the mobile device to reconfigure certain features, e.g. turn on/off location broadcasting, turn on/off ringer, switch to a power saving mode in order to conserve battery life, etc.
commands for the mobile device to erase and/or transfer email messages, text messages, image files, personal contact information, etc. stored in the device.
commands for the mobile device to provide status information through an email message sent to a specified email address, such status information includes in use/standby, battery life remaining, storage capacity, location parameters, etc.

The following examples illustrate usage of the invention:

### EXAMPLE 1

If a user loses access to a mobile device temporarily, e.g. forgets to bring the mobile device to work, the user may miss important phone calls, short messages, and emails directed to the mobile device. The user may use another device such as a second mobile device to send a text message to the mobile device. The message, for example, contains a command:

cd (means call divert) password123 (the password for remote control) 68392828 (the phone number for receiving diverted phone calls)

This command instructs the mobile phones to forward incoming phone calls to the indicated phone number.

The mobile device receives the text message and parses the message to obtain the command and the password. If the password matches a record in the mobile device, under the command, the mobile device changes the configuration and forwards income phone calls to the number indicated.

### EXAMPLE 2

A user may keep personal information such as contacts, schedules, notes, etc. using personal information management (PIM) application on a mobile device. If the user loses the mobile device, the PIM information becomes inaccessible by the user but may be accessible to other people. The user may want to erase the personal information from the lost device and/or transfer the information to another device or the like. An email message containing remote control commands is sent to the lost device. Upon receiving the email, the device parses the message and activates an application to erase the personal information from the device and/or forwards the information to another device or an email address.

In principle, the remote control feature of a mobile device should only be used by an authorized user of the device. In order to use the remote control feature, the user is asked to define a password for the remote access. This password is stored locally in the mobile device. Every remote control message sent to the device should comprise a password and the device executes the command in the message only if the password in the message matches the password stored in the device.

By default, the remote control feature of a mobile device is enabled (on). An authorized user may choose to set the remote control feature either enabled (on) or disabled (off). This configuration, preferably, can only be changed when the authorized user is directly accessing the device, and a secrete code may be required in order to change the configuration.

The invention is further explained in the following exemplary embodiments:

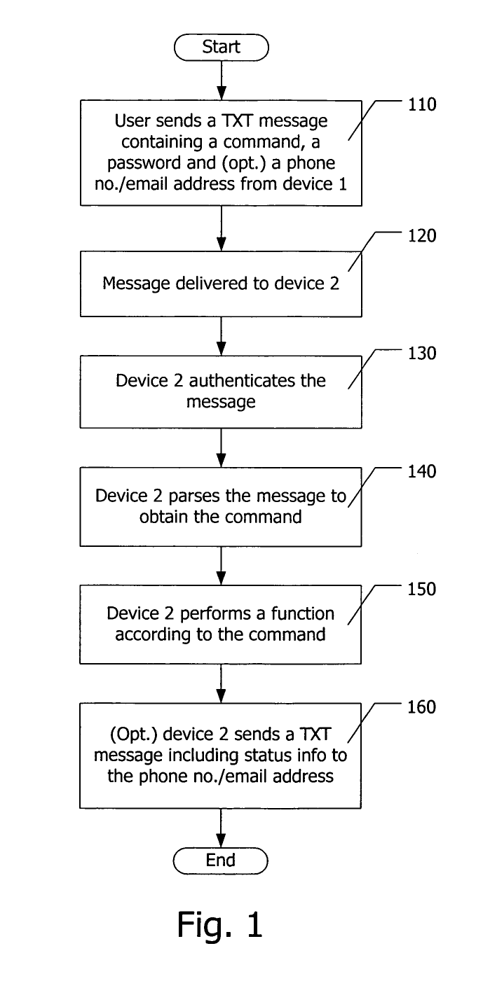

A first embodiment of the invention is illustrated in FIG. 1. In a step 110, from a device (device 1), a user sends a text message comprising a password, a remote control command and, optionally, a phone number or an email address, to a remote mobile device (device 2). In a step 120, the text message is delivered to the mobile device by a text messaging service. In a next step 130, the device 2 authenticates the message by comparing the password. If the password is correct, in a next step 140, the device 2 parses the message to see if it contains any remote control command. In a next step 150, if the message contains a remote control command, the device 2 activates an application according to the command, and the phone number or the email address is used according to the function for forwarding incoming calls or for sending email messages from the mobile device.

In this embodiment, the short text message for remote control, especially the section that contains the password, may be encrypted if such encryption feature is offered by the text messaging service.

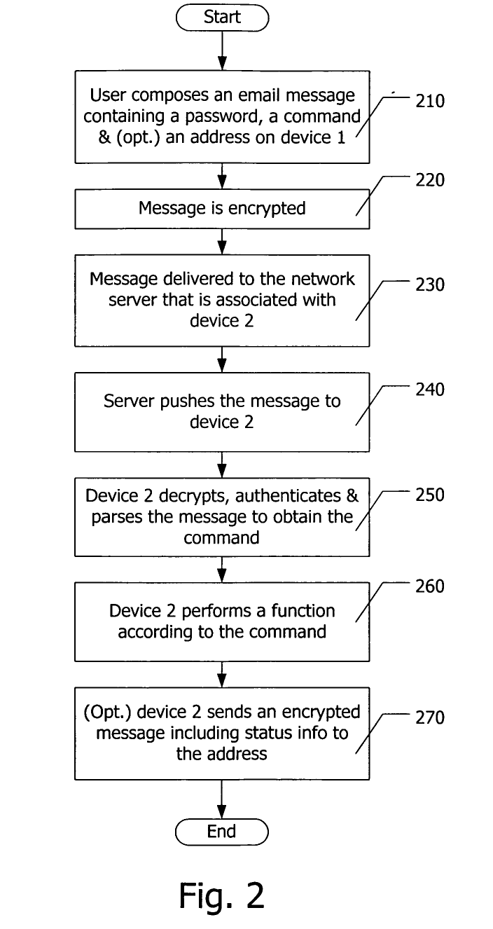

A second embodiment of the invention is illustrated in FIG. 2. In a step 210, from a device (device 1), a user composes an email message comprising a password, a remote control command and, optionally, a return email address or a phone number. In a next step 220, this email message is encrypted via a secure communication application such as NOKIA® PC Suite. In a next step 230, the message is delivered to a network server that hosts the email address associated with a remote mobile device (device 2). In a next step 240, the server pushes the email message to device 2. In a next step 250, the email arrives at device 2. The device 2 decrypts the message. The message is recognized as for remote control (a specially designed application may be used to scan incoming messages for detecting remote control messages, see below). The message is parsed to obtain a password and any remote control command. In a step 260, if the message contains the correct password and a remote command, the mobile device performs a function as indicated in the command, and the phone number or the email address is used according to the function for forwarding incoming calls or for sending email messages from the mobile device. If the command requires sending a return email with status information of the device, in a step 270, the device prepares and sends an encrypted email to the return email address provided in the remote control email message.

A remote controlling message should be so constructed that the mobile device receiving the message would be able to differentiate it with other types of messages that are not intended for remote controlling. Recognizing a remote control message can be achieved by numerous ways. For example, as mentioned above, a specially designed application may be used to scan incoming messages for detecting remote control messages. Various message formats may be used, such as a specially formatted message title that indicates to the remote device that this message is for remote control and the device parses the message only if the title has such indication. Also, a remote control message can be assigned with a special priority, so that any message marked with such priority will be automatically recognized as a remote control message.

The remote control feature can be incorporated as an application into a mobile device's application software. For example, the application may be incorporated into NOKIA® PC Suite for a mobile device. In this particular case, the remote control application would generate a new pair of keys (Public Key and Private Key) each time the mobile device is connected to a PC. This application could assign one of the keys to the mobile device. PC Suite could use the other key to encrypt an email containing a remote control command. PC Suite sends the email to the mobile device. After the mobile device decrypts and parses the email, it activates a corresponding function of the mobile device. The application in the PC Suite ensures the security of the communication and makes the format of the remote control command transparent to end users.

The remote control messages in this invention should be interpreted as encompassing any format of communications that are receivable by a wireless communication device.

The present invention has been disclosed in reference to specific examples therein. Numerous modifications and alternative arrangements may be devised by those skilled in the art without departing from the scope of the present invention, and the appended claims are intended to cover such modifications and arrangements.

What is claimed is:

1. A method, comprising the steps of:
parsing a message delivered to a wireless device,
obtaining a command included in the message, such command indicating a function of the wireless device, and
performing the function indicated by the command.

2. The method of claim 1, wherein the message further comprises a password and the function indicated by the command is performed only if the password matches a record in the wireless device.

3. The method of claim 1, wherein the message further comprises a phone number, and the command causes the wireless device to forward a communication directed to the wireless device to a device associated with the phone number.

4. The method of claim 3, wherein the communication comprises a voice call or a text message.

5. The method of claim 1, wherein the message further comprises an address, and the command causes the wireless device to forward a communication to the address.

6. The method of claim 5, wherein the address is an email address.

7. The method of claim 5, wherein the communication comprises an email message or a text message directed to the wireless device.

8. The method of claim 5, wherein the communication comprises a status message generated by the step of performing the function indicated by the command.

9. The method of claim 1, wherein the command causes the wireless device to modify information stored in the device.

10. The method of claim 1, wherein the command causes the wireless device to change one or more configuration parameters of the device.

11. The method of claim 5, wherein the command causes the wireless device to forward information stored in the device to the address.

12. The method of claim 1, wherein the message is at least partially encrypted according to an algorithm and the method further comprises a step of decrypting the message according to the algorithm.

13. The method of claim 1, wherein the message contains an indication that the message includes the command, and the method further comprises a step of determining whether or not to parse the message according to the indication.

14. The method of claim 1, wherein the message is an email message deliverable by a Push Email service of a wireless communication network.

15. The method of claim 1, wherein the message is a text message deliverable by a text messaging service of a wireless communication network.

16. A wireless device, comprising:
means for parsing a message delivered to the device,
means for obtaining a command included in the message, such command indicating a function of the device, and
means for performing the function indicated by the command.

17. The device of claim 16, wherein the message further comprises a password and the means for performing the function indicated by the command performs the function only if the password matches a record in the device.

18. The device of claim 16, wherein the message further comprises a phone number, and the device further comprises means for forwarding a communication directed to the device to another device associated with the phone number.

19. The device of claim 16, wherein the message further comprises an address, and the device further comprises means for forwarding a communication directed to the device to the address.

20. The device of claim 16, wherein the message further comprises an address, and the device further comprises:
means for composing a status message containing information generated by performing the function indicated by the command, and
means for transmitting the status message to the address.

21. The device of claim 16, wherein the message contains an indication that the message includes the command, and the device further comprises means for determining whether or not to parse the message according to the indication.

22. A computer program product comprising a computer readable storage structure embodying computer program code thereon for execution by a computer processor, comprising:
instructions for parsing a message delivered to the device,
instructions for obtaining a command included in the message, such command indicating a function of the device, and
instructions for performing the function indicated by the command.

23. The computer program product of claim 22, wherein the message further comprises a password and the program product further comprises:
instructions for comparing the password with a record stored in the device; and
instructions for performing the function indicated by the command only if the password matches the record.

24. The computer program product of claim 22, wherein the message further comprises a phone number, and the program product further comprises instructions for forwarding a communication directed to the device to another device associated with the phone number.

25. The computer program product of claim 22, wherein the message further comprises an address, and the program product further comprises instructions for forwarding a communication directed to the device to the address.

26. The computer program product of claim 22, wherein the message further comprises an address, and the program product further comprises:
instructions for composing a status message containing information generated by performing the function indicated by the command, and
instructions for transmitting the status message to the address.

27. The computer program product of claim 22, wherein the message contains an indication that the message includes the command, and the program product further comprises instructions for determining whether or not to parse the message according to the indication.

28. The computer program product of claim 22, wherein the program product is an application incorporated into NOKIA® PC Suite for mobile devices.
